(19) United States
(12) Patent Application Publication
(10) Pub. No.: US 2022/0168948 A1
(43) Pub. Date: Jun. 2, 2022

(54) METHOD FOR SELECTIVE LASER SINTERING, USING THERMOPLASTIC POLYMER POWDERS

(71) Applicant: INEOS STYROLUTION GROUP GMBH, Frankfurt am Main (DE)

(72) Inventors: Bianca WILHELMUS, Hanau (DE); Norbert NIESSNER, Friedelsheim (DE)

(21) Appl. No.: 17/277,486

(22) PCT Filed: Sep. 18, 2019
(86) PCT No.: PCT/EP2019/074961

§ 371 Date: Nov. 16, 2021

(30) Foreign Application Priority Data
Sep. 21, 2018 (EP) 18195869.5

(51) Int. Cl. B29C 64/153; B33Y 70/00

(52) U.S. Cl. CPC B29C 64/153; B29K 2509/02; B33Y 70/00

(57) ABSTRACT

The present invention relates to a process for producing a three-dimensional component by means of selective laser sintering (SLS), wherein a processing temperature Tₓ is established in a build chamber, and a powder layer consisting of a thermoplastic polymer powder is provided in the build chamber. The thermoplastic polymer powder comprises a blend of a semicrystalline polymer, an amorphous polymer and a polymeric compatibilizer. The polymer powder is then melted in a spatially resolved manner by means of a directed beam of electromagnetic radiation, wherein binding of the regions of the melted and resolidified polymer layer by layer in multiple steps affords a three-dimensional component. In the process of the invention, the temperature in the build chamber during the performance of the individual steps varies by not more than +/−10% from the processing temperature Tₓ set. In addition, the processing temperature Tₓ differs by not more than +/−20 K from the processing temperature T_{x(A)} of a polymer powder comprising the corresponding semicrystalline polymer as the sole polymeric component.

The present invention additionally relates to a thermoplastic polymer powder and to the use thereof as material for selective laser sintering (SLS).

The method of selective laser sintering (SLS) is an additive manufacturing (AM) method. It is a particular feature of the methods of additive manufacture, for example selective laser sintering (SLS) and fused deposition modeling (FDM), that no mold is required to manufacture the component. Additive manufacturing methods are typically used for production of small numbers of items, such as prototypes, specimens and models (also referred to as rapid prototyping).

Selective laser sintering (SLS) is a powder bed method wherein thin layers of a polymer powder, typically of thickness about 100 μm, are provided in a build chamber and melted in a spatially resolved manner with the aid of a laser beam. In related methods, the melting can be effected by means of infrared radiation or by means of UV radiation (e.g. UV-LED). The layer-by-layer melting and solidification of the powder particles (sintering) gives rise to the component as the combination of the individual layers.

The method of selective laser sintering and suitable polymer powders are described inter alia in Schmid, M., Selektives Lasersintern (SLS) mit Kunststoffen [Selective Laser Sintering (SLS) with Plastics] (Carl Hanser Verlag Munich 2015).

The method of SLS typically takes place in a heated build chamber. Typically, after the application of a powder layer in the build chamber, for example by means of a squeegee or a roller, energy is introduced to the sites to be melted by exposure to a laser beam. The laser used is often a CO₂ laser, an Nd:YAG laser or a fiber laser. The adjacent polymer particles should ideally not melt as well. After the spatially resolved melting of the polymer particles, the polymer material solidifies again and forms part of the component to be created.

After the complete melting and subsequent resolidification of a component layer, the build chamber is generally lowered, a new powder layer is applied and the build procedure is repeated. By repeated application of new layers and selective melting, it is thus possible to form the desired component layer by layer. On conclusion of the build process and after cooling of the build chamber, unmelted powder is typically removed from the component.

For selective laser sintering, it is possible in principle to use semicrystalline or amorphous polymers. Preference is given to using semicrystalline polymers in SLS, since these have a defined melting point or range and hence enable the building of defined components having satisfactory mechanical properties. However, it is also possible to use amorphous polymers. Amorphous polymers, however, typically result not in densely sintered components but in porous components, since amorphous polymers do not have a defined melting point, but rather a glass transition temperature and a softening range. Components made of amorphous polymers, for example of amorphous polystyrene, are generally porous, have inadequate mechanical strength, and are therefore used predominantly as models for mold casting.

Predominantly polyamides (PA) are used in SLS. It is likewise also possible to process polypropylene (PP), polyoxymethylene (POM), polylactide (PLA) or polystyrene (PS) by means of selective laser sintering (SLS) to give components. SLS methods using various polymers are described in WO 96/06881, the aim being to maximize component density.

For use in SLS, particular demands are placed on the polymer powders, directed to the properties of the polymer (for example mechanical and optical properties, and behavior of the polymer melt) and to the characteristics of the polymer powder (for example particle size, particle size distribution, flowability in the liquid and solid state).

For use in SLS, the average particle size (particle diameter) of the polymer powder must be below the layer density of the layer applied in the build chamber, typically below 200 μm, preferably below 100 μm. Moreover, in general, a homogeneous and not too broad a particle size distribution of the polymer powder is advantageous for the quality of the component. It is especially crucial for use in SLS that the individual polymer powder layers have good and uniform applicability.

It is also important that the polymer powder has good compactibility, such that components having high density and good mechanical properties are obtainable. More particularly, particle size and particle size distribution are crucial for optimal resolution of the component structures.

During the build process, it is advantageous to heat up the build chamber to a temperature (also called processing temperature or process temperature) just below the melting temperature of the semicrystalline polymer or the glass transition temperature of the amorphous polymer, in order to have to introduce only a small portion of the energy needed for melting with the laser beam itself.

When semicrystalline polymers are used, the build chamber is appropriately heated to a temperature above the crystallization temperature of the semicrystalline polymer, in order to avoid premature crystallization and excessive warpage. Warpage is typically understood to mean a variance of the finished component from the target geometry. The difference between crystallization temperature and melting temperature is usually referred to as processing window. The processing window should be sufficiently large to assure a stable and efficiently controllable SLS process.

When amorphous polymers are used, the build chamber should generally not be heated above the glass transition temperature in order to avoid premature liquefaction.

Desirable features for shortening of the cooling phase are firstly a minimum build chamber temperature and secondly a low volume shrinkage of the polymer in the course of cooling. Volume shrinkage is typically understood to mean the decrease in volume (and hence in the dimensions) of the molding as a result of the cooling.

Polymer powder unsintered after a build process is normally removed from the finished component and reused as far as possible in further build cycles. In practice, however, this reuse (recycling) of the polymer powder is distinctly limited since the characteristics of the polymer powder are altered by long built cycle times and high temperatures in the build chamber; more particularly, there is a deterioration in the flowability of the polymer powder. In general, it is therefore necessary to add fresh polymer powder in high proportions, and often to dispose of a high proportion of the used polymer powder. The proportion of the polymer powder reused in the process is indicated by the recycling rate.

Polyamides, especially nylon-12 (abbreviation: PA12; polylauryllactam), are currently used most commonly for selective laser sintering. However, these have some major disadvantages, such as low recycling rate, high volume shrinkage and resultant slow cooling and high build cycle times.

The mechanical properties of SLS components are often inferior to those achievable by other production methods, for instance injection molding. It would therefore be desirable to provide a polymer powder that has better compactibility in selective laser sintering and enables components having improved mechanical properties. Furthermore, components having smoother surfaces are often desirable.

Processes for producing three-dimensional components from amorphous polymers by selective laser sintering are described in CN-B 101 319 075 and EP-A 2 736 964. A process similar to selective laser sintering is described in WO 2016/048357. A light-absorbing additive is applied here to the powder bed at the sites to be compressed, which then absorbs the energy needed to melt the polymer from the radiation, for example from an LED, and transfers it to the polymer to be melted.

WO 2018/046582 describes polymer powders and the use thereof in SLS, wherein the polymer powders comprise a semicrystalline polymer, especially polyamide, an amorphous styrene polymer and a compatibilizer selected from styrene-acrylonitrile-maleic anhydride terpolymers, styrene-N-phenylmaleimide-maleic anhydride terpolymers and methyl methacrylate-maleic anhydride copolymers.

CN-B 101 319 075 describes the use of amorphous SAN copolymer for production of models for mold casting by means of SLS, but the components have an undesirably high porosity.

EP-A 2 736 964 mentions, as a further disadvantage of amorphous polymers, the high viscosity of the melts needed to heat the polymer well above the glass transition temperature with the laser beam in order to enable particles to sinter together. As a result, it is not possible to clearly delimit the melting range, and components having high porosity are obtained.

The prior art likewise discloses methods of additive manufacture in which a polymer powder consisting of multiple different polymers is used. However, the methods described are typically limited to polymers that are miscible with one another at the molecular level. Moreover, the polymer blend powders or the components produced therefrom still have the disadvantages described above.

DE-A 10 2012 015 804 describes polymer powders as material for additive manufacture by way of layer-by-layer melting in a heated build chamber.

The powder is a mixture (blend) of two or more polymers that are miscible at the molecular level, and favorable blends are described as being especially those of semicrystalline polymers, for example PA11/PA12, PA6/PA610, PP/POM/PLA and PP/PA12.

EP-B 0 755 321 describes a process for producing a three-dimensional object, for example by means of SLS, using blends of polymers and copolymers that are mutually miscible at the molecular level. The components are mixed in the melt, with mixing of the polymers taking place at the molecular level. WO 2017/070061 describes the use of a polymer blend composed of a polyolefin and a second thermoplastic polymer, especially a functionalized polyolefin, wherein the second polymer serves to increase the absorption of laser radiation in the polymer blend.

US-A 2011/0129682, EP-A 2 177 557 and WO 2015/081001 describe SLS methods using a blend of two polymer components, wherein polyolefins (e.g. PP and PE) and selectively hydrogenated styrene-butadiene block copolymers are mixed with one another.

Polymer blends composed of polyolefins and amorphous polymers, especially amorphous styrene polymers and styrene copolymers, are known per se and are described, for example, in U.S. Pat. Nos. 3,894,117 and 4,386,187. Owing to the incompatibility of the components, binary blends of polyolefins and styrene polymers or styrene copolymers (e.g. SAN or ABS) have very low toughness. The addition of compatibilizers, as described in U.S. Pat. Nos. 3,894,117 and 4,386,187, can improve the toughness of the blends. Suitable compatibilizers are, for example, block copolymers having a polyolefin sequence and a polystyrene sequence, or polystyrene-polybutadiene-polystyrene block copolymers.

It is an object of the present invention to provide a process for selective laser sintering (SLS) with which the above-described disadvantages of the prior art can be remedied. More particularly, components having good mechanical properties and surface properties are to be produced in a simple, stable and inexpensive method, wherein the components have a low tendency to warpage and low volume shrinkage. Moreover, the process of the invention is to enable shortening of the build time, especially of the cooling time, such that energy and time can be saved and a higher proportion of the polymer powder can be reused in the process (high recycling rate).

It has been found that, surprisingly, blends that have been produced by compounding (mixing) of a semicrystalline polymer A, an amorphous polymer B and a selected compatibilizer C can be used particularly advantageously in selective laser sintering and comparable technologies. The compatibilizer C brings about mixing of the two intrinsically incompatible polymer components at the molecular level to give an interpenetrating network. Since the laser beam in the SLS process only ever melts a small region of the polymer powder, it is advantageous when the components present in the polymer powder are mixed with one another at the molecular level.

It has been found that, inter alia, the polymer powder P has an advantageously large processing window. Surprisingly, the polymer powder P has a processing window (difference between crystallization temperature and melting temperature) that varies by not more than +/−20 K from the processing window of a polymer powder comprising the corresponding semicrystalline polymer A as the sole polymeric component.

It has also been found that, surprisingly, a polymer powder P which is a blend of a semicrystalline polymer A, an amorphous polymer B and a compatibilizer C can be processed particularly advantageously in the SLS method of the invention with observance of particular process parameters. It has been found that it is advantageous to vary the temperature in the build chamber during the performance of the individual steps by not more than +/−10% from the processing temperature Tₓ set. Surprisingly, the components have a volume shrinkage and warpage reduced by at least 10% compared to the volume shrinkage or warpage in the case of use of a polymer powder comprising the corresponding semicrystalline polymer as the sole polymeric component.

It has also been found that the porosity of the component that has been obtained by means of the process of the invention has a distinctly smaller porosity than a component which is obtained using a polymer powder comprising the amorphous polymer B as the sole polymeric component.

The present invention relates to a process for producing a three-dimensional component by means of selective laser sintering, comprising the steps of:
x) setting a processing temperature Tₓ in a build chamber and providing a powder layer consisting of a thermoplastic polymer powder P in the build chamber, where the thermoplastic polymer powder P comprises:
   (A) 10% to 89.9% by weight, preferably 30% to 66% by weight, based on the overall polymer powder P, of at least one semicrystalline polymer A;
   (B) 10% to 89.9% by weight, preferably 30% to 66% by weight, based on the overall polymer powder P, of at least one amorphous polymer B;
   (C) 0.1% to 20% by weight, preferably 1% to 10% by weight, based on the overall polymer powder P, of at least one compatibilizer C;
   (D) optionally 0% to 5% by weight, preferably 0% to 3% by weight, based on the overall polymer powder P, of at least one additive and/or auxiliary;
   where the sum total of the percentages by weight of components A, B, C and optionally D together is 100% by weight;
   and where the semicrystalline polymer A, the amorphous polymer B and the compatibilizer C are in the form of a polymer blend;
xi) spatially resolved melting by means of a directed beam of electromagnetic radiation, followed by solidification of the thermoplastic polymer powder P in a defined region;
where steps x) and xi) are performed repeatedly, such that binding of the regions of the melted and resolidified polymer forms a three-dimensional component layer by layer;
(i) where the temperature in the build chamber during the performance of the individual steps x) and xi) of the process varies by not more than +/−10% from the processing temperature Tₓ set;
(ii) and where the processing temperature Tₓ for the polymer powder P differs by not more than +/−20 K, preferably by not more than +/−10 K, especially preferably by not more than +/−5 K, from the processing temperature T_{x(A)} of a polymer powder comprising the corresponding semicrystalline polymer A as the sole polymeric component.

In the context of the present invention, what is meant by “semicrystalline polymer” is a polymer comprising a certain proportion of crystalline regions consisting of polymer chains in a structured arrangement. Typically, the crystallinity (proportion by weight or molar proportion of crystalline regions based on the overall polymer) of a semicrystalline polymer is in the range from 10% to 80%. The proportion of crystalline regions can be determined, for example, with the aid of known thermal analysis methods (e.g. differential scanning calorimetry DSC, differential thermoanalysis DTA) or by x-ray structure analysis. Semicrystalline polymers generally feature a glass transition temperature and often feature a more or less tightly limited melting point.

In the context of the present invention, what is meant by “amorphous polymer” is a polymer having a zero or indeterminate content of ordered crystalline regions. More particularly, the crystallinity of an amorphous polymer is below 10%, preferably below 1%. Amorphous polymers generally have a glass transition temperature and a broad softening range.

In the context of the present invention, the term “polymer blend” refers to a macroscopically homogeneous mixture of multiple different polymers. More particularly, a polymer blend is produced by mixing the different polymers (A, B and C) in the melt.

The expression “polymer or copolymer comprising or produced from monomer or monomers X” is understood by the person skilled in the art to mean that the structure of the polymer or copolymer is formed in a random, block or other arrangement from the units corresponding to the monomers X mentioned. Correspondingly, the person skilled in the art will understand, for example, the expression “acrylonitrile-butadiene-styrene copolymer (ABS)” to mean the polymer comprising or formed from the monomer units based on acrylonitrile, butadiene, styrene. The person skilled in the art is aware that polymers and copolymers may normally, as well as the monomer units specified, include small amounts of other structures, for example start and end groups.

In the context of the present invention, a method of selective laser sintering (SLS) is understood to mean a method of additive manufacture for production of a three-dimensional body with the aid of an apparatus suitable for SLS.

The processing temperature Tₓ for the SLS method typically refers to the temperature established in the build chamber at the start of the method (before the first step xi). The processing temperature is typically chosen such that the build chamber is heated up to a temperature just below the melting temperature of the polymer powder, in order to have to introduce only a small portion of the energy needed for melting with the laser beam itself. The processing temperature Tₓ for the SLS method is preferably chosen within the temperature range between crystallization temperature and melting temperature.

In the context of the present invention, the processing window refers to a temperature range corresponding to the difference between crystallization temperature and melting temperature for a given polymer powder P. The processing window can be reported either as the temperature range in K (kelvin) or in terms of the absolute position of the temperature range in ° C. (degrees Celsius).

Selective Laser Sintering (SLS) Method

The process of the invention for producing a three-dimensional component by means of selective laser sintering, as described above, comprises the steps of:
x) setting a processing temperature Tₓ in a build chamber and providing a powder layer consisting of the thermoplastic polymer powder P described in the build chamber, and
xi) spatially resolved melting by means of a directed beam of electromagnetic radiation, preferably by means of a laser beam, by means of infrared radiation or by means of UV radiation, followed by solidification of the thermoplastic polymer powder P in a defined region;
   where steps x) and xi) are performed repeatedly, such that binding of the regions of the melted and resolidified polymer forms a three-dimensional component layer by layer. The process may also consist of the steps mentioned.

The processing temperature Tₓ can typically be set before or after the first provision of the powder layer in the build chamber. The processing temperature Tₓ is preferably set before the provision of the powder layer.

The powder layer preferably has a thickness in the range from 10 to 400 μm, preferably from 50 to 300 μm, more preferably from 100 to 200 μm. The powder layer can be provided with the aid of a squeegee, a roller or another suitable device. It is often the case that, after the providing of the powder layer, the excess polymer powder is removed with a squeegee or a roller.

Typically, once steps x) and xi) have been run through, the build chamber is lowered and provided with a new powder layer consisting of polymer powder P. The layer-by-layer melting and solidification of the powder particles (sintering) typically gives rise to the component as the combination of the individual layers.

Suitable devices for selective laser sintering and for related methods of additive manufacture are, for example, Formiga P110, EOS P396, EOSINT P760 and EOSINT P800 (manufacturer: EOS GmbH), 251P and 402p (manufacturer: Hunan Farsoon High-tech Co., Ltd), DTM Sinterstation 2000, ProX SLS 500, sPro 140, sPro 230 and sPro 60 (manufacturer: 3D Systems Corporation) and Jet Fusion 3D (manufacturer: Hewlett Packard Inc.). In the case of the Jet Fusion 3D device (manufacturer: Hewlett-Packard Inc.), the spatially resolved melting is effected with the aid of infrared radiation.

Step x) typically comprises setting the temperature in the build chamber to the processing temperature Tₓ. The processing temperature Tₓ in the process of the invention is preferably within the range from 80 to 200° C., preferably from 90 to 180° C., preferably from 120 to 175° C., especially preferably from 130 to 170° C.

According to the invention, the temperature in the build chamber during the performance of the individual steps x) and xi) of the process of the invention varies by not more than +/−10%, preferably by not more than +/−5%, from the processing temperature Tₓ set. In a preferred embodiment, the processing temperature Tₓ in the process of the invention by means of selective laser sintering is in the range from 80 to 200° C., preferably from 90 to 180° C., especially preferably 120 to 175° C., further preferably from 130 to 170° C., where the temperature varies during the performance of the individual steps x) and xi) by not more than +/−10%, preferably by not more than +/−5%, from the processing temperature Tₓ set.

In a preferred embodiment, the processing window for the polymer powder P in the selective laser sintering method of the invention is from 10 to 110 K (kelvin), preferably 10 to 80 K, more preferably 20 to 70 K. In a preferred embodiment, the processing window of the polymer powder P in the selective laser sintering method of the invention is in the range of 80 to 200° C., preferably from 90 to 180° C., further preferably 120 to 175° C., especially preferably from 130 to 170° C., further preferably from 80 to 120° C. The processing window for a given polymer powder typically describes a temperature range within which the temperature during the SLS method can vary around the processing temperature Tₓ set, with assurance of a stable SLS method.

It has been found that, surprisingly, the thermal properties (ascertained by DSC measurements) and hence the suitable processing temperatures (processing window) of the polymer powders P differ only slightly from the thermal properties and processing temperatures of the polymer powders that are not a blend and comprise the corresponding semicrystalline polymer A as the sole polymeric component. The invention thus relates to a process for producing a three-dimensional component by means of selective laser sintering as described, wherein the processing temperature Tₓ for the polymer powder P differs by not more than +/−20 K, preferably by not more than +/−10 K, more preferably by not more than +/−5 K, from the processing temperature T_{x(A)} of a polymer powder comprising the corresponding semicrystalline polymer A as the sole polymeric component. This is preferably correspondingly applicable to the temperature in the build chamber during the performance of the individual steps x) and xi).

A preferred embodiment further relates to a process for producing a three-dimensional component by means of selective laser sintering as described, wherein the processing window of the polymer powder P in the selective laser sintering method of the invention differs by not more than +/−20 K, preferably by not more than +/−10 K, more preferably by not more than +/−5 K, from the processing window of a polymer powder comprising the corresponding semicrystalline polymer A as the sole polymeric component.

In particular, the absolute position of the processing window of the thermoplastic polymer powder P (which is typically in the range from 80 to 200° C., preferably from 90 to 180° C.) differs by not more than +/−20 K, preferably by not more than +/−10 K, more preferably by not more than +/−5 K, from the processing window of a polymer powder comprising the corresponding semicrystalline polymer A as the sole polymeric component.

It has additionally been found that, surprisingly, volume shrinkage and/or warpage in the production of the three-dimensional component by the process of the invention is distinctly reduced compared to volume shrinkage or warpage in the case of use of a polymer powder comprising the corresponding semicrystalline polymer A as the sole polymeric component.

In a preferred embodiment, the invention relates to a process for producing a three-dimensional component as described, wherein volume shrinkage in the course of production of the three-dimensional component is reduced by at least 10%, preferably by at least 15%, by means of selective laser sintering using the polymer powder P compared to the volume shrinkage when using a polymer powder comprising the corresponding semicrystalline polymer A as the sole polymeric component.

Volume shrinkage in the context of the present invention is understood to mean the decrease in volume of a component in the course of cooling from the processing temperature (process temperature) to room temperature (for example 20° C.). In the case of cubic components, volume shrinkage is composed of shrinkage in x, y and z direction.

In a preferred embodiment, the invention relates to a process for producing a three-dimensional component as described, wherein warpage in the course of production of the three-dimensional component is reduced by at least 10%, preferably by at least 15%, by means of selective laser sintering using the polymer powder P compared to the warpage when using a polymer powder comprising the corresponding semicrystalline polymer A as the sole polymeric component.

Warpage in the context of the present invention is understood to mean the change in shape of a component in the course of cooling from the processing temperature (process temperature) to room temperature (for example 20° C.). For example, warpage can be determined by measuring the geometric variance of a component edge from the straight line of the desired shape. Typically, warpage is determined on standard shaped bodies, for example rods or cubes.

In addition, it has been found that, surprisingly, the porosity of a component made of the polymer powder P (polymer blend composed of semicrystalline polymer A and amorphous polymer B) is lower than the porosity of a component made of the corresponding amorphous polymer B alone. In a preferred embodiment, the invention thus relates to a process for producing a three-dimensional component as described above, wherein the porosity of the three-dimensional component produced from the polymer powder P is at least 10%, preferably at least 15%, lower than the porosity of a component produced from the corresponding amorphous polymer B as the sole polymeric component.

Porosity of the component in the context of the present invention is understood to mean the ratio of cavity volume of the component to total volume of the component. Porosity can often additionally be determined by visual assessment.

### Thermoplastic Polymer Powder P in the SLS Method of the Invention

For selective laser sintering, it is advantageous to use a polymer powder having a controlled particle size. The thermoplastic polymer powder P which is used in the SLS method of the invention preferably has a median particle diameter D₅₀ in the range from 5 to 200 μm, more preferably 5 to 150 μm, especially preferably from 20 to 100 μm, more preferably from 30 to 80 μm. Preference is also given to a range from 30 to 80 μm, further preferably from 40 to 70 μm. Particle sizes and particle size distributions can be determined with the aid of the known methods, e.g. sieve analysis, light scattering measurement, ultracentrifuge (described, for example, in W. Scholtan, H. Lange: Kolloid Z. u. Z. Polymere 250, p. 782-796, 1972).

The median particle diameter D₅₀ is the diameter that divides the cumulative distribution of the particle volumes into two portions of equal size, i.e. 50% of the particles are larger and 50% are smaller than the diameter D₅₀. When density is constant, the proportion by volume also corresponds to the proportion by mass. The D₉₀ indicates the particle size at which 90% of the particles based on the volume or mass are smaller than the value specified. The D₁₀ indicates the particle size at which 10% of the particles based on the volume or mass are smaller than the value specified.

Preference is given to using a thermoplastic polymer powder P having a median particle diameter D₅₀ in the range from 5 to 200 μm in the process of the invention.

In a preferred embodiment, the thermoplastic polymer powder P has a particle diameter D₉₀ (preferably based on the proportion by volume) of less than 200 μm, preferably of less than 180 μm. In a preferred embodiment, the thermoplastic polymer powder P has a proportion by weight of less than 1% of particles having a diameter greater than 200 μm, preferably greater than 180 μm. In a preferred embodiment, the thermoplastic polymer powder P has a proportion by weight of greater than 80%, preferably greater than 90%, of particles having a diameter smaller than 100 μm.

In a further preferred embodiment, the thermoplastic polymer powder P has a multimodal particle size distribution. A multimodal particle size distribution is typically a particle size distribution having more than one maximum. The particle size distribution may preferably have two, three or more maxima. In a preferred embodiment, the thermoplastic polymer powder P has a bimodal particle size distribution (i.e. a particle size distribution having two maxima). One particle size maximum is preferably at a value in the range from 20 to 100 μm, preferably in the range from 30 to 80 μm, and a further particle size maximum is at a value in the range from 0.5 to 30 μm, preferably in the range from 1 to 20 μm.

The thermoplastic polymer powder P used in the process of the invention preferably comprises (or consists of):
(A) 20% to 79.9% by weight, preferably 30% to 66% by weight, especially preferably 35% to 60% by weight, based on the overall polymer powder P, of at least one polymer selected from polyamides, polyoxymethylene, polyether ketones, polylactides, semicrystalline polystyrene, polyethylene terephthalate, polybutylene terephthalate and semicrystalline polyolefins as semicrystalline polymer A;
(B) 20% to 79.9% by weight, preferably 30% to 66% by weight, especially preferably 35% to 60% by weight, based on the overall polymer powder P, of at least one polymer selected from the group consisting of styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), amorphous polystyrene (PS) and impact-modified polystyrene (HIPS) as amorphous polymer B;
(C) 0.1% to 20% by weight, preferably 1% to 15% by weight, more preferably 5% to 10% by weight, based on the overall polymer powder P, of a copolymer selected from the group consisting of styrene-maleic anhydride copolymers, styrene-acrylonitrile-maleic anhydride terpolymers, styrene-N-phenylmaleimide-maleic anhydride terpolymers, methyl methacrylate-maleic anhydride copolymers, styrene-butadiene block copolymers, styrene-polyolefin copolymers, acrylonitrile-styrene-polyolefin copolymers and acrylonitrile-styrene-butadiene-polyolefin copolymers as compatibilizer C;
(D1) optionally 0% to 5% by weight, preferably 0.01% to 5% by weight, more preferably 0.1% to 3% by weight, of at least one silicon dioxide nanoparticle powder or silicone additive as free-flow aid and
(D2) optionally 0% to 5% by weight, preferably 0% to 3% by weight, based on the overall polymer powder P, of at least one further additive and/or auxiliary, preferably at least one antistat, as further component D.

### Component A

Semicrystalline polymers A used may be known semicrystalline thermoplastic polymers, such as polyamides, polyoxymethylene (POM), polyether ketones (PEK), polylactides (PLA), semicrystalline polystyrene (isotactic PS and/or syndiotactic PS), polyethylene terephthalate (PET), polybutylene terephthalate (PBT), semicrystalline polyolefins, such as polyethylene (PE) or polypropylene (PP). Component A is present in the polymer powder to an extent of 10% to 89.9% by weight, preferably 30% to 66% by weight, often 35% to 60% by weight, based on the overall polymer powder P.

Semicrystalline polymers A used may in particular also be mixtures (blends) of the polymers A described.

In a preferred embodiment, the semicrystalline polymer A is at least one semicrystalline polyamide (PA). Suitable polyamides are known homo- and copolyamides, and mixtures thereof. Suitable polyamides and copolyamides are described, for example, in WO 2018/046582.

The semicrystalline polymer A is preferably at least one polyamide selected from the group consisting of polycaprolactam (PA6), polyhexamethyleneadipamide (PA6,6); polytetramethyleneadipamide (PA4,6), polypentamethyleneadipamide (PA5,10), polyhexamethylenesebacamide (PA6,10), polyenantholactam (PA7), polyundecanolactam (PA11) and polylauryllactam (polydodecanolactam, PA12). Polymer A is more preferably at least one polyamide (PA) selected from the group consisting of polycaprolactam (PA6), polyhexamethyleneadipamide (PA6,6); polyundecanolactam (PA11) and polylauryllactam (polydodecanolactam, PA12).

It is typically possible to use a commercially available polyamide, for example of the Vestosint® (Evonik Industries), Vestamid® (Evonik Industries), Ultramid® (BASF SE), Miramid® (BASF SE), Zytel (DuPont), Ubesta® (Ube) or Durethan® (Lanxess) type, as component A in the process of the invention.

As component A of the invention, it is typically also possible to use other commercially available semicrystalline polymers in the process of the invention, for example of the Ingeo® (polylactide, Nature-Works) and/or Xarec® (syndiotactic polystyrene, Idemitsu) type.

In a preferred embodiment, the semicrystalline polymer A is at least one semicrystalline polyolefin, preferably selected from polyethylene, polypropylene and polypropylene-polyethylene copolymers. Typically, component A used may be a commercially available polyolefin, for example an isotactic polypropylene homopolymer (HPP, INEOS Olefins & Polymers), a low-density polyethylene (LD-PE, INEOS Olefins & Polymers), a linear low-density polyolefin (LLD-PE, INEOS Olefins & Polymers), a medium-density polyolefin (MD-PE, INEOS Olefins & Polymers), a high-density polyethylene (HD-PE, INEOS Olefins & Polymers) or a polypropylene-polyethylene copolymer.

Polypropylenes suitable as semicrystalline polymer A typically have a melt flow index (MFR, 230° C., 2.16 kg, ISO 1133) in the range from 2 to 100 g/10 min, preferably 5 to 50 g/10 min. Polyethylenes suitable as semicrystalline polymer A typically have a melt flow index (MFR, 190° C., 2.16 kg, ISO 1133) in the range from 0.1 to 50 g/10 min, preferably 0.25 to 30 g/10 min, more preferably 0.5 to 10 g/10 min.

### Component B

The amorphous polymer B is preferably an amorphous thermoplastic polymer, preferably a thermoplastic amorphous styrene homopolymer and/or styrene copolymer.

In one embodiment, the amorphous polymer B is an amorphous styrene homopolymer and/or amorphous styrene copolymer, wherein styrene may be wholly or partly replaced by other vinylaromatic monomers, especially alpha-methylstyrene, para-methylstyrene and/or C₁-C₄-alkylstyrene. Preferably, the amorphous polymer B is a polymer or copolymer comprising at least 10% by weight, preferably at least 20% by weight, more preferably at least 40% by weight, based on the polymer B, of styrene and/or alpha-methylstyrene.

A preferred styrene polymer or styrene copolymer in the context of the invention is understood to mean a polymer comprising at least 10% by weight of styrene and/or alpha-methylstyrene, excluding semicrystalline styrene polymers (isotactic and syndiotactic polystyrene).

Amorphous polymers B used in the process of the invention may be known amorphous thermoplastic styrene polymers and/or styrene copolymers. In a preferred embodiment, the amorphous polymer B is at least one polymer selected from styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)methylstyrene-acrylonitrile copolymers (AMSAN), styrene-methyl methacrylate copolymers (SMMA), amorphous polystyrene (PS), and impact-modified polystyrene (HIPS).

The styrene copolymers mentioned are typically commercially available, for example from INEOS Styrolution (Frankfurt).

Component B is present in the polymer powder P at generally 10% to 89% by weight, preferably 30% to 66% by weight, based on the overall polymer powder.

In a preferred embodiment, the amorphous polymer B is an impact-modified polystyrene (also referred to as rubber-modified polystyrene) (high-impact polystyrene resin, HIPS), preferably comprising a polybutadiene rubber and/or a styrene-butadiene rubber. For example, it is possible to use HIPS polymers of the INEOS Styrolution® PS HIPS type (INEOS Styrolution, Frankfurt).

In a preferred embodiment, the amorphous polymer B is at least one styrene polymer or styrene copolymer having a melt volume flow rate measured to ISO 1133 (220° C./load of 10 kg or 200° C./load of 5 kg), in the range from 2 to 60 cm³/10 min, preferably 5 to 40 cm³/10 min.

Particular preference is given to the use of free-flowing styrene copolymers as amorphous polymer B, especially an acrylonitrile-butadiene-styrene copolymer (ABS) having a melt volume flow rate, measured to ISO 1133 (220° C. and load of 10 kg) in the range from 5 to 40 cm³/10 min.

In a further preferred embodiment, the amorphous polymer B is at least one ABS copolymer comprising (preferably consisting of):
B1: 5% to 95% by weight, preferably 40% to 80% by weight, of at least one thermoplastic copolymer B1 prepared from:
   B1a: 50% to 95% by weight, preferably 65% to 80% by weight, more preferably 69% to 80% by weight, based on copolymer B1, of a monomer B1a selected from styrene, α-methylstyrene or mixtures of styrene and at least one further monomer selected from α-methylstyrene, p-methylstyrene and C₁-C₈-alkyl (meth)acrylates (e.g. methyl methacrylate, ethyl methacrylate, n-butyl acrylate, t-butyl acrylate),
   B1b: 5% to 50% by weight, preferably 20% to 35% by weight, more preferably 20% to 31% by weight, based on copolymer B1, of a monomer B1b selected from acrylonitrile or mixtures of acrylonitrile and at least one further monomer selected from methacrylonitrile, anhydrides of unsaturated carboxylic acids (e.g. maleic anhydride, phthalic anhydride) and imides of unsaturated carboxylic acids (e.g. N-substituted maleimides, such as N-cyclohexylmaleimide and N-phenylmaleimide),
B2: 5% to 95% by weight, preferably 20% to 60% by weight, of at least one graft copolymer B2 comprising:
   B2a: 40% to 85% by weight, preferably 50% to 80% by weight, more preferably 55% to 70% by weight, based on graft copolymer B2, of at least one graft base B2a which is obtained by emulsion polymerization of:
      B2a1: 50% to 100% by weight, preferably 80% to 100% by weight, based on the graft base B2a, of butadiene,
      B2a2: 0% to 50% by weight, preferably 0% to 20% by weight, more preferably 0% to 10% by weight, based on the graft base B2a, of at least one further monomer B2a2 selected from styrene, α-methylstyrene, acrylonitrile, methacrylonitrile, isoprene, chloroprene, C₁-C₄-alkylstyrene, C₁-C₈-alkyl (meth)acrylate, alkylene glycol di(meth)acrylate and divinylbenzene;
   where the sum of B2a1+B2a2 adds up to exactly 100% by weight; and
B2b: 15% to 60% by weight, preferably 20% to 50% by weight, more preferably 30% to 45% by weight, based on the graft copolymer B2,
   of a graft shell B2b which is obtained by emulsion polymerization in the presence of the at least one graft base B2a of:
      B2b1: 50% to 95% by weight, preferably 65% to 80% by weight, more preferably 75% to 80% by weight, based on the graft shell B2b, of a monomer B2b1 selected from styrene or mixtures of styrene and at least one further monomer selected from α-methylstyrene, p-methylstyrene and C₁-C₈-alkyl (meth)acrylates (e.g. methyl methacrylate, ethyl methacrylate, n-butyl acrylate, t-butyl acrylate);
      B2b2: 5% to 50% by weight, preferably 20% to 35% by weight, more preferably 20% to 25% by weight, based on the graft shell B2b, of a monomer B2b2 selected from acrylonitrile or mixtures of acrylonitrile and at least one further monomer selected from methacrylonitrile, anhydrides of unsaturated carboxylic acids (e.g. maleic anhydride, phthalic anhydride) and imides of unsaturated carboxylic acids (e.g. N-substituted maleimides, such as N-cyclohexylmaleimide and N-phenylmaleimide);
         where the sum total of graft base B2a and graft shall B2b is exactly 100% by weight.

In a preferred embodiment, the amorphous polymer B is an acrylonitrile-butadiene-styrene copolymer (ABS), for example of the Terluran® or Novodur® type (both INEOS Styrolution).

In a further preferred embodiment, the amorphous polymer B is a styrene-acrylonitrile copolymer (SAN), especially a non-rubber-modified styrene-acrylonitrile copolymer, for example of the Luran® type (INEOS Styrolution), and/or an α-methylstyrene-acrylonitrile copolymer (AMSAN), for example of the Luran® High Heat type (INEOS Styrolution).

SAN copolymers and AMSAN copolymers generally comprise 18% to 35% by weight, preferably 20% to 32% by weight, more preferably 22% to 30% by weight, of acrylonitrile (AN), and 82% to 65% by weight, preferably 80% to 68% by weight, more preferably 78% to 70% by weight, of styrene (S) or α-methylstyrene (AMS), where the sum of styrene or α-methylstyrene and acrylonitrile adds up to 100% by weight.

The SAN and AMSAN copolymers used generally have an average molar mass M_{w} of 80 000 to 350 000 g/mol, preferably of 100 000 to 300 000 g/mol and more preferably of 120 000 to 250 000 g/mol.

In a preferred embodiment, the amorphous polymer B is at least one SAN copolymer comprising (preferably consisting of):
50% to 95% by weight, preferably 65% to 80% by weight, more preferably 69% to 80% by weight, especially preferably 71% to 80% by weight, based on polymer B, of at least one monomer selected from styrene, α-methylstyrene or mixtures of styrene and α-methylstyrene, and
5% to 50% by weight, preferably 20% to 35% by weight, more preferably 20% to 31% by weight, especially preferably 20% to 29% by weight, based on polymer B, of a monomer selected from acrylonitrile or mixtures of acrylonitrile and methacrylonitrile.

In a further preferred embodiment, the amorphous polymer B is a transparent methyl methacrylate-acrylonitrile-butadiene-styrene copolymer (MABS), especially at least one copolymer of the Terlux® (INEOS Styrolution) or Toyolac® (Toray) type.

### Component C

As component C, the thermoplastic polymer powder P which is used in the process of the invention comprises at least one compatibilizer. A compatibilizer is typically a polymer, preferably a copolymer or terpolymer. More particularly, the polymer used as compatibilizer is capable of compatibilizing two or more partly or completely incompatible polymers, with a smaller domain size of the compatibilized polymer components than without compatibilizer for a defined melt temperature. These compatibilizers especially contribute to an improvement in mechanical properties, such as tensile strength and impact resistance.

The amount of the compatibilizer C in the thermoplastic polymer powder P (polymer blends) is in the range from 0.1% to 20% by weight, preferably from 1% to 15% by weight. The compatibilizer C is especially preferably present in the polymer powder P at from 1% to 12% by weight, often between 5% and 10% by weight.

The compatibilizer C is preferably a copolymer selected from the group consisting of styrene-maleic anhydride copolymers, styrene-acrylonitrile-maleic anhydride terpolymers, styrene-N-phenylmaleimide-maleic anhydride terpolymers, methyl methacrylate-maleic anhydride copolymers, styrene-butadiene block copolymers, styrene-polyolefin copolymers, styrene-butadiene-polyolefin copolymers, acrylonitrile-styrene-polyolefin copolymers and acrylonitrile-styrene-butadiene-polyolefin copolymers.

In a preferred embodiment, the compatibilizer C is at least one copolymer selected from styrene-acrylonitrile-maleic anhydride terpolymers, styrene-N-phenylmaleimide-maleic anhydride terpolymers and methyl methacrylate-maleic anhydride copolymers, especially preferably styrene-acrylonitrile-maleic anhydride terpolymers and/or a styrene-N-phenylmaleimide-maleic anhydride terpolymer. Preference is given to using a compatibilizer C comprising maleic anhydride monomer units in combination with a polyamide as component A.

Suitable compatibilizers are described in WO 2018/046582. Suitable methyl methacrylate-maleic anhydride copolymers comprising methyl methacrylate, maleic anhydride and optionally a further vinylic copolymerizable monomer, and the use thereof as compatibilizers, are described in WO 98/27157.

The compatibilizer C used is preferably at least one terpolymer based on styrene, acrylonitrile and maleic anhydride. The ratio between styrene and acrylonitrile in the styreneacrylonitrile-maleic anhydride terpolymer is preferably in the range from 80:20 to 50:50. The ratio between styrene and N-phenylmaleimide in the styrene-N-phenylmaleimide-maleic anhydride terpolymer is preferably in the range from 80:20 to 50:50. In order to improve the miscibility of the terpolymer or copolymer (compatibilizer C) with the polymers A and B, preference is given to selecting an amount of styrene corresponding to the amount of vinyl monomers in the styrene copolymer B. The styrene-acrylonitrile-maleic anhydride terpolymers used as compatibilizer C generally have molecular weights M_{W} in the range from 30 000 to 500 000 g/mol, preferably from 50 000 to 250 000 g/mol, especially from 70 000 to 200 000 g/mol, determined by GPC using tetrahydrofuran (THF) as eluent and with polystyrene calibration.

In a further preferred embodiment, the compatibilizer C is a copolymer selected from the group consisting of styrene-butadiene block copolymers, styrene-polyolefin copolymers (preferably selected from styrene-ethylene-propylene copolymers, styrene-ethylene copolymers, styrene-ethylene-butylene copolymers, styrene-propylene-butylene copolymers, styrene-butylene copolymers and styrene-propylene copolymers), styrene-butadiene-polyolefin copolymers (preferably selected from styrene-butadiene-ethylene copolymers, styrene-butadiene-ethylene-propylene copolymers, styrene-butadiene-butylene copolymers and styrene-butadiene-propylene copolymers), acrylonitrile-styrene-polyolefin copolymers (preferably selected from acrylonitrile-styrene-ethylene copolymers and acrylonitrile-styrene-propylene copolymers) and acrylonitrile-styrene-butadiene-polyolefin copolymers. Preference is given to using a compatibilizer C comprising styrene monomer units in combination with a polyolefin as component A.

In a preferred embodiment, the compatibilizer C is at least one copolymer selected from styrene-butadiene block copolymers, styrene-ethylene-propylene copolymers, styrene-ethylene copolymers, styrene-ethylene-butylene copolymers, styrene-propylene-butylene copolymers, styrene-butylene copolymers, acrylonitrile-styrene-ethylene copolymers and acrylonitrile-styrene-propylene copolymers. The compatibilizer C is especially preferably at least one copolymer selected from star-shaped styrene-butadiene block copolymers, linear styrene-butadiene block copolymers, styrene-ethylene-propylene block copolymers, styrene-ethylene-butylene block copolymers, acrylonitrile-styrene-ethylene copolymers and acrylonitrile-styrene-propylene copolymers.

The copolymers used as compatibilizer C are often commercially available, for example from INEOS Styrolution GmbH, from Kuraray Europe, from Kraton Polymers or from NOF Corporation.

In a preferred embodiment, the compatibilizer C comprises at least one styrene-butadiene block copolymer. The compatibilizer C is preferably at least one styrene-butadiene block copolymer comprising (preferably consisting of) 40% to 80% by weight, preferably 50% to 80% by weight, based on the overall styrene-butadiene block copolymer, of styrene and 20% to 60% by weight, preferably 20% to 50% by weight, based on the overall styrene-butadiene block copolymer, of butadiene.

Suitable styrene-butadiene block copolymers are described, for example, in WO2016/034609, WO2015/121216 and WO2015/004043. Processes for preparing linear and star-shaped branched styrene-butadiene block copolymers are known to those skilled in the art and are described, for example, in the documents cited above.

Compatibilizers C used may be linear and/or star-shaped branched styrene-butadiene block copolymers. For example, it is possible to use linear styrene-butadiene block copolymers of the Styroflex® type (e.g. Styroflex® 2G 66, INEOS Styrolution) and/or star-shaped branched styrene-butadiene block copolymers of the Styrolux® type (e.g. Styrolux® 3G 55, Styrolux® 693 D, Styrolux® 684 D, INEOS Styrolution).

The compatibilizer C preferably comprises at least one styrene-butadiene block copolymer comprising at least one homogeneous hard styrene block S and at least one soft block consisting of 40% to 100% by weight of butadiene and 0% to 60% by weight of styrene. The styrene-butadiene block copolymer preferably comprises at least one homogeneous hard styrene block S and at least one mixed soft block S/B consisting of 20% to 60% by weight of styrene and 40% to 80% by weight of butadiene. For example, the styrene-butadiene block copolymer may have at least one S1-S/B-S2 sequence.

The styrene monomer of the styrene-butadiene block copolymer may be partly or wholly replaced by other vinylaromatic monomers, such as: α(alpha)-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 1,1-diphenylethylene, 4-(4-phenyl-n-butyl)styrene, 1-vinylnaphthalene and 2-vinylnaphthalene, preferably α-methylstyrene, methylstyrene and 1,1-diphenylethylene.

The butadiene is preferably 1,3-butadiene. The butadiene monomer of the styrene-butadiene block copolymer may be partly or wholly replaced by other conjugated diene monomers, preferably having 4 to 12 carbon atoms, more preferably having 4 to 8 carbon atoms, for example 2-methyl-1,3-butadiene (isoprene), 2-ethyl-1,3-butadiene, 2,3-dimethyl-1,3-butadiene, 1,3-pentadiene, 3-butyl-1,3-octadiene and mixtures thereof, preferably 2-methyl-1,3-butadiene (isoprene).

In a particularly preferred embodiment, the compatibilizer C is a styrene-butadiene block copolymer or a combination of a styrene-butadiene block copolymer and a further polymer selected from styrene-polyolefin copolymers, acrylonitrile-styrene-polyolefin copolymers and acrylonitrile-styrene-butadiene-polyolefin copolymers, preferably selected from styrene-ethylene-propylene block copolymers.

### Component D

The thermoplastic polymer powder P which is used in the process of the invention may optionally comprise at least one additive and/or one auxiliary as further component D. Component D is present in the polymer powder at from 0% to 5% by weight, often from 0% to 3% by weight, frequently from 0.1% to 3% by weight.

The optional component D is preferably at least one additive and/or one auxiliary selected from antioxidants, UV stabilizers, stabilizers against thermal breakdown, peroxide destroyers, antistats, lubricants, free-flow aids, demolding agents, nucleating agents, plasticizers, fibrous or pulverulent fillers and reinforcers, and colorants, such as dyes and pigments.

Useful additives or auxiliaries include the polymer additives that are known to the person skilled in the art and described in the prior art (e.g. Plastics Additives Handbook, editors: Schiller et al., 6th edition 2009, Hanser). The additive and/or auxiliary can be added either at the early stage of compounding (mixing of the polymeric components A, B and C in the melt) or before or after mechanical comminution of the polymer.

The optional component D is preferably selected from the group consisting of antioxidants, UV stabilizers, stabilizers against thermal decomposition, peroxide destroyers, antistats, lubricants, free-flow aids, demolding agents, nucleating agents, plasticizers, fibrous or pulverulent fillers and reinforcers (glass fibers, carbon fibers, etc.), and colorants, such as dyes and pigments.

Lubricants and demolding agents, which can generally be used in amounts of up to 1% by weight, are, for example, long-chain fatty acids such as stearic acid or behenic acid, salts thereof (e.g. calcium stearate or zinc stearate) or esters thereof (e.g. stearyl stearate or pentaerythritol tetrastearate), and amide derivatives (e.g. ethylenebisstearylamide). For better processing, it is possible to add mineral-based antiblocking agents to the polymer powders P in amounts of up to 0.1% by weight. Examples include amorphous or crystalline silica, calcium carbonate or aluminum silicate.

Additives of particularly good suitability for improving the flowability of the polymer powder in liquid and solid form are silicon dioxide nanoparticle powders (e.g. Aerosil® from Evonik) or silicone additives (e.g. Genioplast® from Wacker). In a preferred embodiment, the thermoplastic polymer powder P comprises 0.01% to 5% by weight, preferably 0.1% to 3% by weight, of at least one silicon dioxide nanoparticle powder or silicone additive as additive D.

Processing auxiliaries used may, for example, be mineral oil, preferably medicinal white oil, in amounts of up to 5% by weight, preferably up to 2% by weight.

Examples of suitable fillers and reinforcers are carbon fibers, glass fibers, amorphous silica, calcium silicate (wollastonite), aluminum silicate, magnesium carbonate, calcium carbonate, barium sulfate, kaolin, chalk, powdered quartz, mica and feldspar.

The thermoplastic polymer powder P typically comprises additives and/or auxiliaries in an amount in the range from 0% to 5% by weight, preferably 0% to 3% by weight, especially 0.1% to 5% by weight, preferably 0.1% to 5% by weight, further preferably 0.5% to 3% by weight, based on the overall polymer powder P. The upper limits for components A and/or B in the polymer powder P may be adjusted appropriately in the presence of the optional component D (e.g. 10% to 84.9% by weight or 10% to 86.9% by weight of A or B, based on the polymer powder P).

The optional component D may be added during the mixing of the polymeric components A, B and C (compounding), after compounding, during the mechanical comminution or after the mechanical comminution of the polymer.

### Process for Preparing the Thermoplastic Polymer Powder P

The processes for preparing the thermoplastic polymer powder P are essentially known and are described, for example, in WO 2018/046582. The production of the thermoplastic polymer powder P typically comprises the following steps:

i) providing a solid-state mixture comprising (preferably consisting of) components A, B, C and optionally D, preferably obtained by mixing components A, B, C and optionally D in the melt, for example in an extruder, and cooling the melt;
ii) mechanically comminuting the solid-state mixtures, especially by means of grinding, micronizing, cryogenic grinding or jet grinding;
to obtain a thermoplastic polymer powder P having a median particle diameter D50 in the range from 5 to 200 μm, preferably 5 to 150 μm, especially preferably 20 to 100 μm, particularly preferably from 30 to 80 μm.

Step i) preferably comprises mixing (compounding) components A, B and C in the liquid state, preferably in the melt, especially at a temperature in the range from 200 to 250° C. The mixing of components A, B and C and optionally D is typically performed in a suitable extruder, for example a twin-screw extruder. It is also possible in principle to use other known mixing apparatus, such as Brabender mills or Banbury mills. The person skilled in the art will choose the compounding conditions, for example the compounding temperature, depending on the components used, especially the polymeric components A and B. Mixing of components A, B and C and optionally D with maximum intensity is advantageous here.

Step i) preferably comprises the cooling and pelletizing of the polymer mixture.

Preference is given to mechanically comminuting the solid-state mixtures in step ii) by means of grinding, micronizing, cryogenic grinding or jet grinding. Suitable methods of mechanical comminution, especially by grinding, are described, for example, in Schmid, M., Selektives Lasersintern (SLS) mit Kunststoffen, p. 105-113 (Carl Hanser Verlag Munich 2015). The grinding is preferably effected while cooling, for instance by means of dry ice, liquid CO₂ or liquid nitrogen. The method of cryogenic grinding features a combination of very low temperatures and a mechanical grinding process. The method is described, for example, in Liang, S. B. et al. (Production of Fine Polymer Powders under Cryogenic Conditions, Chem. Eng. Technol. 25 (2002), p. 401-405).

### Thermoplastic Polymer Powder P of the Invention

The present invention additionally relates to a thermoplastic polymer powder P comprising:
(A) 10% to 89.9% by weight, preferably 30% to 66% by weight, based on the overall polymer powder P, of at least one semicrystalline polymer A;
(B) 10% to 89.9% by weight, preferably 30% to 66% by weight, based on the overall polymer powder P, of at least one amorphous polymer B;
(C) 0.1% to 20% by weight, preferably 1% to 10% by weight, based on the overall polymer powder P, of at least one compatibilizer C;
(D) optionally 0% to 5% by weight, preferably 0% to 3% by weight, based on the overall polymer powder P, of at least one additive and/or auxiliary;
where the sum total of the percentages by weight of components A, B, C and optionally D together is 100% by weight;
where the semicrystalline polymer A, the amorphous polymer B and the compatibilizer C are in the form of a polymer blend;
where the thermoplastic polymer powder P has a median particle diameter D50 in the range from 5 to 200 μm;
wherein the processing window of the thermoplastic polymer powder P in the process of selective laser sintering is in the range from 80 to 250° C., preferably 80 to 200° C., especially preferably from 90 to 180° C., and wherein the processing window of the thermoplastic polymer powder P differs by not more than +/−20 K, preferably by not more than +/−10 K, more preferably by not more than +/−5 K, from the processing window of a polymer powder comprising the corresponding semicrystalline polymer A as the sole polymeric component.

In particular, the absolute position of the processing window of the thermoplastic polymer powder P (which is typically in the range from 80 to 200° C., preferably from 90 to 180° C.) differs by not more than +/−20 K, preferably by not more than +/−10 K, more preferably by not more than +/−5 K, from the processing window of a polymer powder comprising the corresponding semicrystalline polymer A as the sole polymeric component.

The above-described embodiments with regard to components A, B, C and D of the polymer powder P and with regard to the properties of the polymer powder P are correspondingly applicable to the polymer powder P of the invention.

### Use of the Thermoplastic Polymer Powder P

The present invention additionally relates to a use of the thermoplastic polymer powder P of the invention for production of a three-dimensional component by means of selective laser sintering (SLS) or related methods of additive manufacture.

The embodiments described above, for example with regard to components A, B, C and D, are correspondingly applicable to the use of the invention.

The resultant components can be used in various ways, for example as a component of motor vehicles and aircraft, ships, packaging, sanitary articles, medical products, input devices and operating elements, laboratory equipment and consumer goods, machine parts, domestic appliances, furniture, handles, seals, floor coverings, textiles, agricultural equipment, footwear soles, vessels for storage of food and animal feed, dishware, cutlery, filters, telephone equipment, or as a prototype or model in industry, design and architecture.

### ELUCIDATION OF THE DRAWINGS

FIG. 1 shows an illustrative representation of the particle size distribution of a powder of the invention. What is shown is the particle size distribution density q₃(x) or cumulative particle size distribution Q₃(x) as a function of particle size x in μm (micrometers). The D₁₀ (x_{10,3}), D₅₀ (x_{50,3}) and D₉₀ (x_{90,3}) values are stated.

FIG. 2 shows an illustrative representation of diffuse reflection R (in %) as a function of wavenumber k (in cm⁻¹) for some of the powders of the invention.

FIG. 3 shows the DSC curves of powder P1 of the invention with a first heating operation (1. AH), cooling (K) and second heating operation (2. AH). What is plotted is the amount of heat supplied or removed (in mW/mg of sample) as a function of temperature T (in ° C.). The results for the cooling (K) are: peak (crystallization) 118.3° C.; onset 110.5° C.; end 122.9° C.; area −52.91 J/g; glass transition T_{g} 67.5° C. The results for the first heating operation (1. AH) are: peak (melting) 165.7° C.; onset 151.7° C.; end 171.1° C.; area 47.75 J/g; glass transition T_{g} 100.6° C. The results for the second heating operation (2. AH) are: peak (melting) 162.1° C.; onset 153.6° C.; end 168.4° C.; area 50.63 J/g; glass transition T_{g} 101.5° C.

FIG. 4 shows the DSC curves of powder P4 of the invention with a first heating operation (1. AH), cooling (K) and second heating operation (2. AH). What is plotted is the amount of heat supplied or removed (in mW/mg of sample) as a function of temperature T (in ° C.). The results for the cooling K are: peak (crystallization) 118.2° C.; onset 113.3° C.; end 123.0° C. The results for the first heating operation (1. AH) are: peak (melting) 165.5° C.; onset 151.6° C.; end 171.3° C.

The results for the second heating operation (2. AH) are: peak (melting) 162.2° C.; onset 155.5° C.; end 168.5° C.

FIG. 5 shows transmission electron micrographs of specimens that have been produced from the blends of the invention: 5a) illustrative polymer blend (example P1) with good compatibilization, 5b) comparative image of an uncompatibilized polymer blend (comparative example V1).

The invention is elucidated further by the examples and claims that follow.

### EXAMPLES

### 1.1 Components Used

The following semicrystalline polyolefins A1 and A2 were used as component A:
A1 isotactic PP (100-HR25, INEOS Olefins & Polymers)
A2 LD-PE (18R430, INEOS Olefins & Polymers)

Component B1 used was a highly impact-resistant acrylonitrile-butadiene-styrene (ABS) polymer of the Terluran® type (INEOS Styrolution, Frankfurt) having a melt volume flow rate (MVR 220° C./load 10 kg, ISO 1133) of about 6 cm³/10 min.

Component B2 used was an impact-resistant amorphous polystyrene (HIPS) (INEOS Styrolution, Frankfurt) having a melt volume flow rate (melt volume rate 200° C./load 5 kg, ISO 1133) of about 4 cm³/10 min.

The following compatibilizers are used as component C:
C1 star-shaped styrene-butadiene block copolymer, Styrolux® type (INEOS Styrolution), butadiene content 25% by weight, melt volume flow rate (MVR) to ISO 1133 of 11 cm³/10 min;
C2 linear styrene-butadiene block copolymer, Styroflex® type (INEOS Styrolution) of the S-(B/S)-S structure, butadiene content 35% by weight, melt volume flow rate (MVR) to ISO 1133 of 13 cm³/10 min;
C3 styrene-ethylene-propylene block copolymer (Septon 2104, Kuraray Europe);
C4 styrene-ethylene-butylene block copolymer (G 1650 E, Kraton Polymers);
C5 styrene-ethylene-propylene block copolymer (G 1701 E, Kraton Polymers);
C6 polyethylene-acrylonitrile-styrene copolymer (Modiper AS100, NOF Corp.);
C7 polypropylene-acrylonitrile-styrene copolymer (Modiper A3400, NOF Corp.)

An antistat was used as component D.

The polymer mixtures (polymer blends) P1 to P23 and V1 to V8 were produced as described under 1.2. The illustrative polymer blends are summarized in table 1 below. Compositions V1 to V8 are comparative experiments (without addition of the compatibilizer C).

TABLE 1
Compositions of the polymer blends (all values in %
by weight based on the overall polymer blend)

| Ex. | A1 | A2 | B1 | B2 | C1 | C2 | C3 | C4 | C5 | C6 | C7 | D |
|---|---|---|---|---|---|---|---|---|---|---|---|---|
| P1 | 46.0 | | | 46.0 | | | 8.0 | | | | | |
| P2 | | 46.0 | | 46.0 | | 8.0 | | | | | | |
| P3 | 23.0 | | | 69.0 | | | 8.0 | | | | | |
| P4 | 69.0 | | | 23.0 | | | 8.0 | | | | | |
| P5 | | 45.5 | | 45.5 | | | 8.0 | | | | | 1.0 |
| P6 | | 45.5 | | 45.5 | | | | 8.0 | | | | 1.0 |
| P7 | 46.0 | | | 46.0 | 8.0 | | | | | | | |
| P8 | 49.5 | | | 49.5 | | | | | | | 1.0 | |
| P9 | 48.5 | | | 48.5 | | | | | | | 3.0 | |
| P10 | 47.5 | | | 47.5 | | | | | | | 5.0 | |
| P11 | 46.0 | | | 46.0 | | | | | 8.0 | | | |
| P12 | 49.5 | | 49.5 | | | | | | | | 1.0 | |
| P13 | 48.5 | | 48.5 | | | | | | | | 3.0 | |
| P14 | 47.5 | | 47.5 | | | | | | | | 5.0 | |
| P15 | 49.5 | | | 49.5 | | | | | | 1.0 | | |
| P16 | 48.5 | | | 48.5 | | | | | | 3.0 | | |
| P17 | 47.5 | | | 47.5 | | | | | | 5.0 | | |
| P18 | 49.5 | | 49.5 | | | | | | | 1.0 | | |
| P19 | 48.5 | | 48.5 | | | | | | | 3.0 | | |
| P20 | 47.5 | | 47.5 | | | | | | | 5.0 | | |
| P21 | 46.0 | | 46.0 | | 8.0 | | | | | | | |
| P22 | 46.0 | | 46.0 | | 4.0 | | 4.0 | | | | | |
| P23 | 46.0 | | | 46.0 | 4.0 | | 4.0 | | | | | |
| V1 | 50.0 | | | 50.0 | | | | | | | | |
| V2 | 50.0 | | 50.0 | | | | | | | | | |
| V3 | | 49.5 | 49.5 | | | | | | | | | 1.0 |
| V4 | | 49.5 | | 49.5 | | | | | | | | 1.0 |
| V5 | 100 | | | | | | | | | | | |
| V6 | | 100 | | | | | | | | | | |
| V7 | | | 100 | | | | | | | | | |
| V8 | | | | 100 | | | | | | | | |

### 1.2 Production of the Polymer Blends

All materials were predried at 80° C. for 14 hours. The semicrystalline polyolefin A, the amorphous polymer B, the compatibilizer C and any component D were compounded in a corotating twin-screw extruder of the Process 11 brand, manufacturer: Thermo Scientific, at a melt temperature of 220° C. to 240° C. The screw diameter of the twin-screw extruder was 11 mm; the screw speed was 220 rpm. Subsequently, the material was extruded through an extrusion die having a diameter of 2.2 mm into a water bath and pelletized. The throughput was between 1.5 and 2.3 kg/h.

### 1.3 Characterization of the Blends

The polymer blends were characterized using tensile specimens of the 1A type to ISO 527 that were produced by means of injection molding.

The notched impact resistance aₖ of the polymer blends was determined to ISO 179 1eA. Tensile tests were conducted to ISO 527. The results of the tests are listed in table 2.

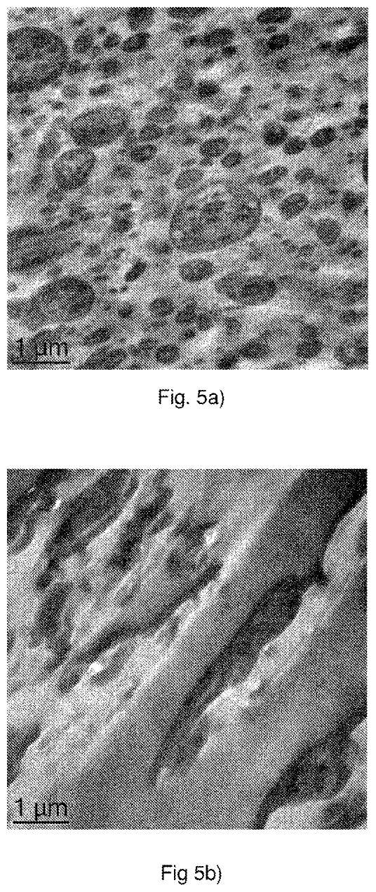

The mechanical properties thus determined on the injection-molded tensile specimens are considered to be an indication of the quality of the polymer blends. Transmission electron micrographs were taken as a further indication of good compatibilization of the blends. FIG. 5a shows an illustrative image of polymer blend P1 of the invention, and FIG. 5b, by way of comparison, an image of the uncompatibilized polymer blend V1.

TABLE 2
Characterization of the polymer blends

| | Notched impact | Modulus of | Tensile | Elongation |
|---|---|---|---|---|
| | resistance | elasticity | strength σ_{M} | at break |
| Sample | aₖ [kJ/m²] | Eₜ [MPa] | [MPa] | ε_{B} [%] |
| P1 | 4.1 | 1200 | 25.7 | 52.9 |
| P2 | 1.9 | 420 | 10.8 | 8.1 |
| P3 | 5.6 | 1490 | 25.9 | 23.8 |
| P4 | 5.8 | 1460 | 28.8 | 101.9 |
| P5 | 14.4 | 241 | 12.6 | 23.9 |
| P6 | 2.7 | 438 | 9.9 | 15.5 |
| P7 | 2.1 | 1470 | 25.7 | 9.1 |
| P8 | 1.9 | 1460 | 24.5 | 2.3 |
| P9 | 1.9 | 1460 | 24.6 | 2.3 |
| P10 | 2.0 | 1450 | 24.8 | 2.4 |
| P11 | 5.0 | 962 | 18.1 | 3.2 |
| P12 | 2.9 | 1500 | 25.8 | 4.3 |
| P13 | 2.1 | 1530 | 25.6 | 3.9 |
| P14 | 2.2 | 1530 | 25.9 | 3.8 |
| P15 | 1.3 | 1500 | 24.9 | 2.1 |
| P16 | 1.3 | 1460 | 25.3 | 3.5 |
| P17 | 1.4 | 1440 | 23.2 | 1.9 |
| P18 | 2.3 | 1500 | 24.8 | 3.9 |
| P19 | 2.1 | 1440 | 24.3 | 4.0 |
| P20 | 2.3 | 1410 | 23.0 | 3.6 |
| P21 | 4.2 | 1410 | 27.2 | 10.6 |
| P22 | 4.2 | 1400 | 27.3 | 14.6 |
| P23 | 7.8 | 1220 | 25.1 | 75.5 |
| V1 | 1.9 | 1440 | 24.4 | 3.1 |
| V2 | 2.3 | 1490 | 24.2 | 4.8 |
| V3 | 3.1 | 665 | 12.5 | 4.8 |
| V4 | 2.6 | 506 | 7.7 | 7.6 |

### 1.4 Production of the Polymer Powders P

The polymer blends (pellets produced according to 1.2) were micronized in two stages. First of all, the pellets that had been precooled with liquid nitrogen were comminuted in a high-speed rotor mill (Pulverisette 14, manufacturer: Fritsch).

Thereafter, the powders thus obtained were ground to ultrafine powders in a stirred ball mill (PE5, manufacturer: Netzsch) with ZrO₂ grinding balls in ethanol.

### 1.5 Characterization of the Polymer Powders P

### 1.5.1 Particle Size Distribution

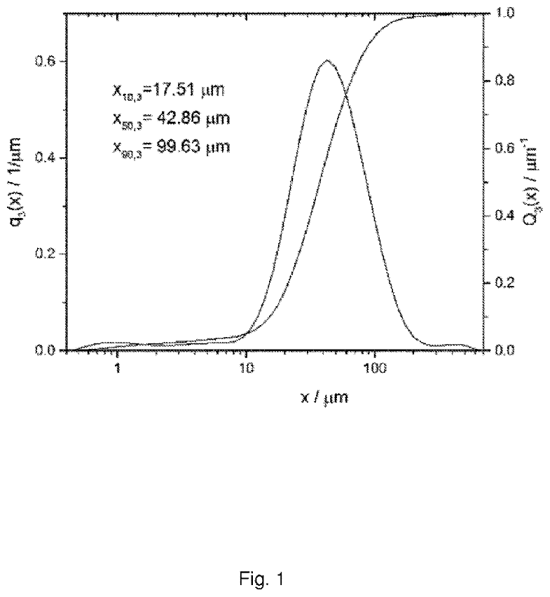

Particle size distribution was measured by means of laser diffractometry in a Mastersizer 2000 (manufacturer: Malvern Instruments). The measurement for sample P1 is shown by way of example in FIG. 1. All the polymer powders produced had a median particle diameter D50 in the range from 25 to 55 μm.

### 1.5.2 Optical Properties

An important optical property of the polymer powders is their ability to absorb the energy introduced by the laser.

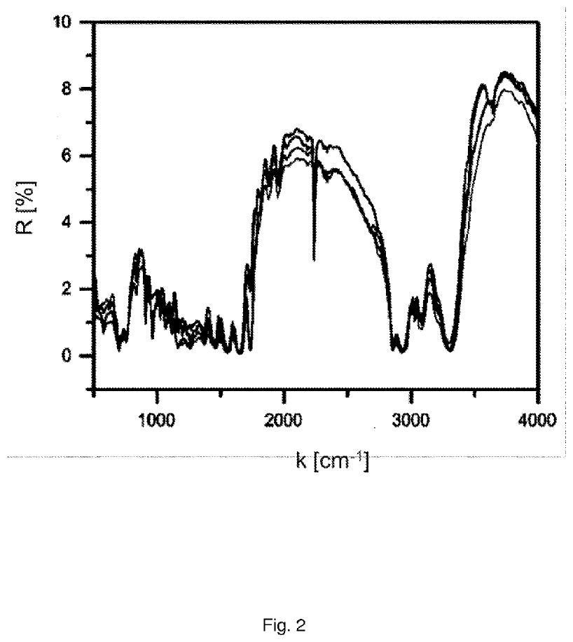

The absorption of the powders was analyzed by means of diffuse reflection infrared Fourier transformation spectroscopy (DRIFTS). The wavenumber of the laser used in the SLS process was 943 cm⁻¹, and so the absorption of the polymer in this range was of particular relevance. For the analysis, an FTIR spectrometer (Nicolet 6700, manufacturer: Thermo Scientific) with DRIFTS accessory from PIKE technologies was used. FIG. 2 shows illustrative measurements that show a low reflection and hence high absorption of the powders of the invention at 943 cm⁻¹.

### 1.5.3 Thermal Properties

The estimation of the processing temperature and the determination of the processing window in the SLS process are typically effected on the basis of DSC measurements in accordance with DIN EN ISO 11357. For this purpose, a Q 2000 DSC instrument (manufacturer: TA Instruments) was used. The measurements were conducted with a heating and cooling rate of 10 K/min under a nitrogen atmosphere. The sample mass was about 5 mg.

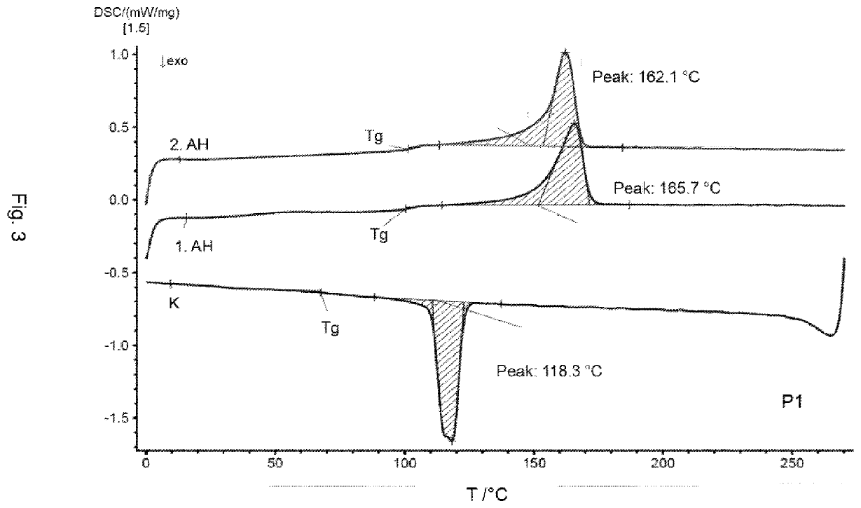

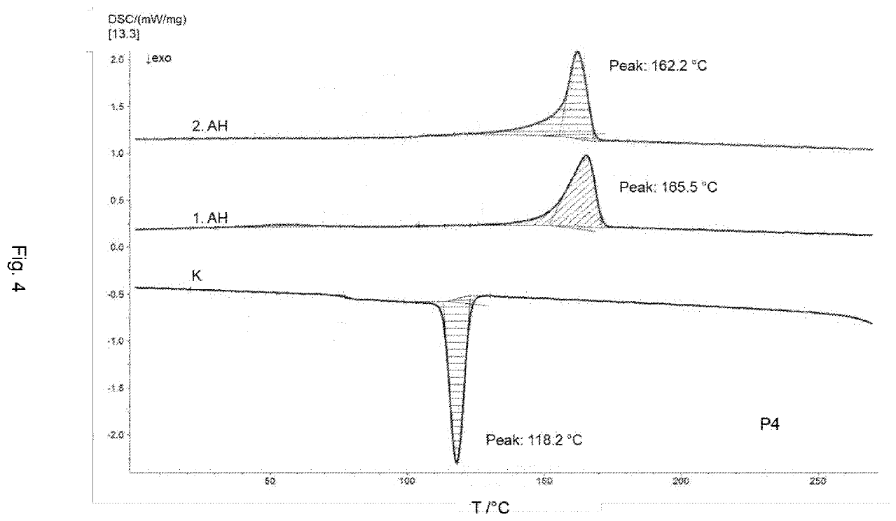

FIG. 3 and FIG. 4 show, by way of example, the DSC curves of the polymer powders P1 and P4. It becomes clear that both polymer powders have an advantageously large processing window (difference between crystallization temperature and melting temperature) of about 44 K (kelvin).

### 2.1 Performance of the Laser Sintering Experiments

The polymer powders P1, P3, P4, P5, P12, V5-V8 produced according to 1.4 were used to conduct various selective laser sintering methods in order to test the suitability of the powders for selective laser sintering. Additionally tested as comparison V9 was a commercial PA12 powder for the SLS method (PA 2200, manufacturer: EOS GmbH). The results are compiled in table 3.

The experiments were conducted on a Formiga P110 (manufacturer: EOS) and on a DTM 2000 sintering station (manufacturer: 3D Systems). All tests were conducted under a nitrogen atmosphere.

The laser power was varied between 4 and 25 W. The scan speed, i.e. the speed with which the laser beam was moved over the powder bed, was varied between 1.0 and 3.4 m/s. The hatch distance (also called trace width) is defined as the distance between the intensity maxima of two laser lines running alongside one another, and was varied between 0.08 and 0.25 mm. The energy density per unit area was 0.01 to 0.085 J/mm². The energy density per unit area is typically calculated from the laser power divided by the scan speed and the hatch distance.

The powder beds with the compositions P1 to P23 described in table 1 had a smooth surface and clear lines around the exposed polymer particles.

For assessment of the powders and for discovery of the optimal settings for laser power, scan speed and hatch distance, individual layers having an edge length of 40×40×0.1 mm were first produced. The use of individual layers as specimens generally allows the influence of the material application on the resultant melt depths to be balanced out, and the beam-material interaction to be analyzed directly. The small amount of sample of a few grams required additionally usually enables efficient analysis of the samples.

Once the optimal settings for laser power, scan speed and hatch distance had been found, tensile specimens of the 1A type to ISO 527 were produced.

### 2.2 Assessment of the Tensile Specimens Obtained by SLS

Notched impact resistance aₖ was determined to ISO 179 1eA on the test specimens obtained according to 2.1. Tensile tests were conducted to ISO 527. The values measured with regard to breaking strength and modulus of elasticity were compared with injection-molded test specimens made from the same polymer blends. The following classification was used for the mechanical properties:

| | | |
|---|---|---|
| + | good | 30% below injection molding |
| ◯ | moderate | 50% below injection molding |
| − | poor | 80% below injection molding |

The assessment of some selected samples and comparative samples is detailed in table 3.

The surface quality of the test specimens was determined visually and with a microscope (Profilm3D Optical Profiler, manufacturer: Filmetrics, with 5× objective). The following classification was used here:

| | | |
|---|---|---|
| ++ | very good | smooth, small visual difference from injection- |
| | | molded parts |
| + | good | slightly corrugated, some visual difference from in- |
| | | jection-molded parts |
| ◯ | moderate | rough, high visual difference from injection-molded |
| | | parts |
| − | poor | very rough, very high visual difference from injec- |
| | | tion-molded parts |

The processing window indicates the difference between crystallization temperature and melting temperature, and was determined by means of differential scanning calorimetry (DSC).

Volume shrinkage, defined as the decrease in volume of a component in the course of cooling from the processing temperature Tₓ (process temperature) to room temperature (especially 20° C.), was determined by measuring the geometric change in length in x, y and z direction and multiplying these three values.

Warpage, defined as the change in shape of a component in the course of cooling from the processing temperature Tₓ (process temperature) to room temperature (especially 20° C.), was determined by measuring the geometric variance of a component edge from a straight line. This is dependent on the component geometry, for example on the length of the component edge, and so the assessment was made relative to a tensile specimen according to ISO 179 1eA. The comparative sample (reference) used was sample V9.

TABLE 3
Assessment of SLS tensile specimens

| | | Processing | | Volume | Warpage | |
|---|---|---|---|---|---|---|
| | Surface | window | | shrinkage | (relative to V9) | Mechanical |
| Ex. | quality | [° C.] | C. | [%] | [% vs. V9] | properties |
| P1 | ++ | 118-162 | 44 | 1.0 | 10% lower | + |
| P3 | ++ | 118-162 | 44 | 0.8 | 15% lower | + |
| P4 | ++ | 118-162 | 44 | 1.2 | 5% lower | + |
| P5 | ++ | 90-105 | 15 | 1.0 | 10% lower | + |
| P12 | ++ | 117-161 | 44 | 1.0 | 10% lower | + |
| V5 | ∘ | 116-163 | 47 | 1.5 | 5% higher | ∘ |
| V6 | ∘ | 92-106 | 14 | 1.5 | 5% higher | ∘ |
| V7 | − | no | | 0.6 | 20% lower | − |
| | | crystallization | | | | |
| V8 | − | no | | 0.6 | 20% lower | − |
| | | crystallization | | | | |
| V9 | + | 147-184 | 37 | 1.5 | Reference | + |

(V9: PA12 powder, PA 2200, manufacturer: EOS GmbH)

1. A process for producing a three-dimensional component by means of selective laser sintering, comprising the steps of:
x) setting a processing temperature Tₓ in a build chamber and providing a powder layer consisting of a thermoplastic polymer powder P in the build chamber, where the thermoplastic polymer powder P comprises:
(A) 10% to 89.9% by weight, based on the overall polymer powder P, of at least one semicrystalline polymer A;
(B) 10% to 89.9% by weight, based on the overall polymer powder P, of at least one amorphous polymer B;
(C) 0.1% to 20% by weight, based on the overall polymer powder P, of at least one compatibilizer C;
(D) optionally 0% to 5% by weight, based on the overall polymer powder P, of at least one additive and/or auxiliary;
where the sum total of the percentages by weight of components A, B, C and optionally D together is 100% by weight;
and where the semicrystalline polymer A, the amorphous polymer B and the compatibilizer C are in the form of a polymer blend;
xi) spatially resolved melting by means of a directed beam of electromagnetic radiation, followed by solidification of the thermoplastic polymer powder P in a defined region;
where steps x) and xi) are performed repeatedly, such that binding of the regions of the melted and resolidified polymer forms a three-dimensional component layer by layer;
(i) where the temperature in the build chamber during the performance of the individual steps x) and xi) of the process varies by not more than +/−10% from the processing temperature Tₓ set;
(ii) and where the processing temperature Tₓ for the polymer powder P differs by not more than +/−20 K from the processing temperature T_{x(A)} of a polymer powder comprising the corresponding semicrystalline polymer A as the sole polymeric component.

2. The process for producing a three-dimensional component according to claim 1, characterized in that the powder layer has a thickness in the range from 10 to 400 μm.

3. The process for producing a three-dimensional component according to claim 1 or 2, characterized in that the polymer powder P has a median particle diameter D50 in the range from 5 to 200 μm.

4. The process for producing a three-dimensional component according to any of claims 1 to 3, characterized in that the processing temperature Tₓ is in the range from 80 to 250° C.

5. The process for producing a three-dimensional component according to any of claims 1 to 4, characterized in that volume shrinkage in the course of production of the three-dimensional component is reduced by at least 10% by means of selective laser sintering using the polymer powder P compared to the volume shrinkage when using a polymer powder comprising the corresponding semicrystalline polymer A as the sole polymeric component.

6. The process for producing a three-dimensional component according to any of claims 1 to 5, characterized in that warpage in the course of production of the three-dimensional component is reduced by at least 10% by means of selective laser sintering using the polymer powder P compared to the warpage when using a polymer powder comprising the corresponding semicrystalline polymer A as the sole polymeric component.

7. The process for producing a three-dimensional component according to any of claims 1 to 6, characterized in that the processing window of the polymer powder P in the process of selective laser sintering is from 10 to 80 K.

8. The process for producing a three-dimensional component according to any of claims 1 to 7, characterized in that the porosity of the three-dimensional component produced from the polymer powder P is at least 10% lower than the porosity of a component produced from the corresponding amorphous polymer B as the sole polymeric component.

9. The process for producing a three-dimensional component according to any of claims 1 to 8, characterized in that the semicrystalline polymer A is at least one polymer selected from polyamides, polyoxymethylene, polyether ketones, polylactides, semicrystalline polystyrene, polyethylene terephthalate, polybutylene terephthalate and semicrystalline polyolefins.

10. The process for producing a three-dimensional component according to any of claims 1 to 9, characterized in that the amorphous polymer B is at least one polymer selected from the group consisting of styrene-acrylonitrile copolymers, acrylonitrile-butadiene-styrene copolymers, acrylate-styrene-acrylonitrile copolymers, methyl methacrylate-acrylonitrile-butadiene-styrene copolymers, methyl methacrylate-butadiene-styrene copolymers, α(alpha)-methylstyrene-acrylonitrile copolymers, styrene-methyl methacrylate copolymers, amorphous polystyrene and impact-modified polystyrene.

11. The process for producing a three-dimensional component according to any of claims 1 to 10, characterized in that the compatibilizer C is at least one copolymer selected from the group consisting of styrene-maleic anhydride copolymers, styrene-acrylonitrile-maleic anhydride terpolymers, styrene-N-phenylmaleimide-maleic anhydride terpolymers, methyl methacrylate-maleic anhydride copolymers, styrene-butadiene block copolymers, styrene-polyolefin copolymers, styrene-butadiene-polyolefin copolymers, acrylonitrile-styrene-polyolefin copolymers and acrylonitrile-styrene-butadiene-polyolefin copolymers.

12. The process for producing a three-dimensional component according to any of claims 1 to 11, characterized in that the amorphous polymer B is at least one styrene polymer or styrene copolymer having a melt volume flow rate, measured to ISO 1133, in the range from 2 to 60 cm³/10 min.

13. The process for producing a three-dimensional component according to any of claims 1 to 12, characterized in that the polymer powder P comprises:
(A) 20% to 79.9% by weight, based on the overall polymer powder P, of at least one polymer selected from polyamides, polyoxymethylene, polyether ketones, polylactides, semicrystalline polystyrene, polyethylene terephthalate, polybutylene terephthalate and semicrystalline polyolefins as semicrystalline polymer A;
(B) 20% to 79.9% by weight, based on the overall polymer powder P, of at least one polymer selected from the group consisting of styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), amorphous polystyrene (PS) and impact-modified polystyrene (HIPS) as amorphous polymer B;
(C) 0.1% to 20% by weight, based on the overall polymer powder P, of a copolymer selected from the group consisting of styrene-acrylonitrile-maleic anhydride terpolymers, styrene-N-phenylmaleimide-maleic anhydride terpolymers, methyl methacrylate-maleic anhydride copolymers, styrene-butadiene block copolymers, styrene-polyolefin copolymers, acrylonitrile-styrene-polyolefin copolymers and acrylonitrile-styrene-butadiene-polyolefin copolymers as compatibilizer C;
(D1) optionally 0% to 3% by weight of at least one silicon dioxide nanoparticle powder or silicone additive as free-flow aid, and
(D2) optionally 0% to 3% by weight, based on the overall polymer powder P, of at least one further additive and/or auxiliary as further component D.

14. A thermoplastic polymer powder P comprising:
(A) 10% to 89.9% by weight, based on the overall polymer powder P, of at least one semicrystalline polymer A;
(B) 10% to 89.9% by weight, based on the overall polymer powder P, of at least one amorphous polymer B;
(C) 0.1% to 20% by weight, based on the overall polymer powder P, of at least one compatibilizer C;
(D) optionally 0% to 5% by weight, based on the overall polymer powder P, of at least one additive and/or auxiliary;
where the sum total of the percentages by weight of components A, B, C and optionally D together is 100% by weight;
where the semicrystalline polymer A, the amorphous polymer B and the compatibilizer C are in the form of a polymer blend;
where the thermoplastic polymer powder P has a median particle diameter D50 in the range from 5 to 200 μm;
wherein the processing window of the thermoplastic polymer powder P in the process of selective laser sintering is in the range from 80 to 250° C., and wherein the processing window of the thermoplastic polymer powder P differs by not more than +/−20 K from the processing window of a polymer powder comprising the corresponding semicrystalline polymer A as the sole polymeric component.

15. The use of the thermoplastic polymer powder P according to claim 14 for production of a three-dimensional component by means of selective laser sintering or related methods of additive manufacture.
